(19) United States
(12) Patent Application Publication
(10) Pub. No.: US 2026/0369281 A1
(43) Pub. Date: Nov. 19, 2026

(54) DIFFUSE-PRESERVING MERGING OF MASA AND ISM METADATA

(71) Applicant: NOKIA TECHNOLOGIES OY, Espoo (FI)

(72) Inventors: Jouni Kristian PAULUS, Hersbruck (DE); Tapani PIHLAJAKUJA, Kellokoski (FI); Mikko-Ville LAITINEN, Espoo (FI)

(21) Appl. No.: 19/158,783

(22) PCT Filed: Feb. 1, 2024
(86) PCT No.: PCT/EP2024/052451

§ 371 Date: Aug. 21, 2025

(30) Foreign Application Priority Data
Feb. 23, 2023 (GB) 2302631.3

(51) Int. Cl. G10L 19/008

(52) U.S. Cl. CPC G10L 19/008

(57) ABSTRACT

An apparatus comprising means for: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter, generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

### FIELD

The present application relates to apparatus and methods for merging of MASA and ISM metadata aiming to preserve diffuse parameters, not exclusively for audio encoding.

### BACKGROUND

Parametric spatial audio capture from inputs, such as microphone arrays and other sources, is a typical and an effective choice to estimate from the input (microphone array signals) a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total and diffuse-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and, for example, a stereo or mono signal can be generated from the microphone array signals to be conveyed with the spatial metadata.

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio, object-based audio, and scene-based audio inputs including spatial information about the sound field and sound sources. The codec is also expected to operate with low latency to enable conversational services as well as support high error robustness under various transmission conditions.

The stereo signal could be encoded, for example, using an IVAS audio core codec, or with an AAC (Advanced Audio Coding) or EVS (Enhanced Voice Services) encoder. A decoder can decode the audio signals into PCM (Pulse code modulation) signals and process the sound in frequency bands (using the spatial metadata) to obtain the spatial output, for example, a binaural output.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is provided an apparatus comprising means for: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

The means for selecting based on a comparison of the at least one first weighting value and the second weighting value one of the at least one first direct-to-total ratio parameter and the diffuse-energy compensated direct-to-total ratio parameter may be further for: selecting one of the at least one first direct-to-total ratio parameter when the at least one first weighting value is greater than the second weighting value; and selecting the diffuse-energy compensated direct-to-total ratio parameter when the second weighting value is greater than the at least one first weighting value.

The means for selecting one of the at least one first direct-to-total ratio parameter when the at least one first weighting value is greater than the second weighting value may be when the at least one first weighting value is strictly greater than the second weighting value.

The means for selecting the diffuse-energy compensated direct-to-total ratio parameter when the second weighting value is greater than the at least one first weighting value may be when the second weighting value is strictly greater than the at least one first weighting value.

The means for generating the at least one first weighting value based on the at least one first direct-to-total ratio parameter and the first signal energy parameter may be for generating the at least one first weighting value based on a multiplication of the at least one first direct-to-total ratio parameter and the first signal energy parameter.

The at least one first direct-to-total ratio may comprise at least two first direct-to-total ratios, wherein the means for generating the at least one first weighting value based on the at least one first direct-to-total ratio parameter and the first signal energy parameter may be for generating first weighting values associated with each of the at least two first direct-to-total ratio parameters.

The means for generating first weighting values associated with each of the at least two first direct-to-total ratio parameters may be for generating each first weighting value based on a multiplication of each of the at least one first direct-to-total ratio parameter and the first signal energy parameter.

The means for selecting based on a comparison of the at least one first weighting value and the second weighting value one of the at least one first direct-to-total ratio parameter and the diffuse-energy compensated direct-to-total ratio parameter may be further for: selecting the at least two first direct-to-total ratio parameters when the first weighting values are both greater than the second weighting value; and selecting the diffuse-energy compensated direct-to-total ratio parameter and one of the at least two first direct-to-total ratio parameters when the second weighting value is greater than one of the at least two first weighting values.

The means for generating a second weighting value based, in part, at least one of: the second direct-to-total ratio parameter; the diffuse-energy compensated direct-to-total ratio parameter; and the second signal energy parameter may be for one of: generating the at least one second weighting value based on a multiplication of the at least one second direct-to-total ratio parameter and the second signal energy parameter; generating the at least one second weighting value based on a multiplication of the diffuse-energy compensated direct-to-total ratio parameter and the second signal energy parameter; and generating the at least one second weighting value based on an average of the diffuse-energy compensated direct-to-total ratio parameter and the at least one second direct-to-total ratio parameter multiplied by the second signal energy parameter.

The means for generating a diffuse-energy compensated direct-to-total ratio parameter may be for generating at least one merged diffuse-to-total ratio based at least in part on the first signal energy parameter, the second signal energy parameter and a diffuse signal energy parameter.

The means for may be further for: obtaining, for the first audio stream at least one first diffuse-to-total ratio parameter; and obtaining the diffuse signal energy parameter based, in part, on the first signal energy parameter and the first diffuse-to-total ratio parameter.

The means for generating a diffuse-energy compensated direct-to-total ratio parameter may be for generating the at least one diffuse-energy compensated direct-to-total ratio parameter based on the at least one merged diffuse-to-total ratio.

The means for may be further for obtaining, for the second audio stream at least one second diffuse-to-total ratio parameter, wherein the means for generating at least one merged diffuse-to-total ratio may be further for generating the at least one merged diffuse-to-total ratio based on the second diffuse-to-total ratio parameter.

The means for generating the diffuse-energy compensated direct-to-total ratio parameter may be further for: generating at least one prospective diffuse-energy compensated direct-to-total ratio parameter based on the at least one merged diffuse-to-total ratio; comparing the at least one prospective diffuse-energy compensated direct-to-total ratio parameter to the second direct-to-total ratio parameter; selecting the diffuse-energy compensated direct-to-total ratio parameter from the at least one prospective diffuse-energy compensated direct-to-total ratio parameter and the second direct-to-total ratio parameter based on the comparing, such that the diffuse-energy compensated direct-to-total ratio parameter is the smaller of the at least one prospective diffuse-energy compensated direct-to-total ratio parameter and the second direct-to-total ratio parameter.

The means may be further for encoding the selected one of the at least one first direct-to-total ratio parameter and the diffuse-energy compensated direct-to-total ratio parameter.

The means for may be further for merging the first audio stream and the second audio stream.

According to a second aspect there is provided a method comprising: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

Selecting based on a comparison of the at least one first weighting value and the second weighting value one of the at least one first direct-to-total ratio parameter and the diffuse-energy compensated direct-to-total ratio parameter may further comprise: selecting one of the at least one first direct-to-total ratio parameter when the at least one first weighting value is greater than the second weighting value; and selecting the diffuse-energy compensated direct-to-total ratio parameter when the second weighting value is greater than the at least one first weighting value.

Selecting one of the at least one first direct-to-total ratio parameter when the at least one first weighting value is greater than the second weighting value may be when the at least one first weighting value is strictly greater than the second weighting value.

Selecting the diffuse-energy compensated direct-to-total ratio parameter when the second weighting value is greater than the at least one first weighting value may be when the second weighting value is strictly greater than the at least one first weighting value.

Generating the at least one first weighting value based on the at least one first direct-to-total ratio parameter and the first signal energy parameter may comprise generating the at least one first weighting value based on a multiplication of the at least one first direct-to-total ratio parameter and the first signal energy parameter.

The at least one first direct-to-total ratio may comprise at least two first direct-to-total ratios, wherein generating the at least one first weighting value based on the at least one first direct-to-total ratio parameter and the first signal energy parameter may comprise generating first weighting values associated with each of the at least two first direct-to-total ratio parameters.

Generating first weighting values associated with each of the at least two first direct-to-total ratio parameters may comprise generating each first weighting value based on a multiplication of each of the at least one first direct-to-total ratio parameter and the first signal energy parameter.

Selecting based on a comparison of the at least one first weighting value and the second weighting value one of the at least one first direct-to-total ratio parameter and the diffuse-energy compensated direct-to-total ratio parameter may comprise: selecting the at least two first direct-to-total ratio parameters when the first weighting values are both greater than the second weighting value; and selecting the diffuse-energy compensated direct-to-total ratio parameter and one of the at least two first direct-to-total ratio parameters when the second weighting value is greater than one of the at least two first weighting values.

Generating a second weighting value based, in part, at least one of: the second direct-to-total ratio parameter; the diffuse-energy compensated direct-to-total ratio parameter; and the second signal energy parameter may comprise one of: generating the at least one second weighting value based on a multiplication of the at least one second direct-to-total ratio parameter and the second signal energy parameter; generating the at least one second weighting value based on a multiplication of the diffuse-energy compensated direct-to-total ratio parameter and the second signal energy parameter; and generating the at least one second weighting value based on an average of the diffuse-energy compensated direct-to-total ratio parameter and the at least one second direct-to-total ratio parameter multiplied by the second signal energy parameter.

Generating a diffuse-energy compensated direct-to-total ratio parameter may comprise generating at least one merged diffuse-to-total ratio based at least in part on the first signal energy parameter, the second signal energy parameter and a diffuse signal energy parameter.

The method may further comprise: obtaining, for the first audio stream at least one first diffuse-to-total ratio parameter; and obtaining the diffuse signal energy parameter based, in part, on the first signal energy parameter and the first diffuse-to-total ratio parameter.

Generating a diffuse-energy compensated direct-to-total ratio parameter may comprise generating the at least one diffuse-energy compensated direct-to-total ratio parameter based on the at least one merged diffuse-to-total ratio.

The method may further comprise obtaining, for the second audio stream at least one second diffuse-to-total ratio parameter, wherein generating at least one merged diffuse-to-total ratio may further comprise generating the at least one merged diffuse-to-total ratio based on the second diffuse-to-total ratio parameter.

Generating the diffuse-energy compensated direct-to-total ratio parameter may further comprise: generating at least one prospective diffuse-energy compensated direct-to-total ratio parameter based on the at least one merged diffuse-to-total ratio; comparing the at least one prospective diffuse-energy compensated direct-to-total ratio parameter to the second direct-to-total ratio parameter; selecting the diffuse-energy compensated direct-to-total ratio parameter from the at least one prospective diffuse-energy compensated direct-to-total ratio parameter and the second direct-to-total ratio parameter based on the comparing, such that the diffuse-energy compensated direct-to-total ratio parameter is the smaller of the at least one prospective diffuse-energy compensated direct-to-total ratio parameter and the second direct-to-total ratio parameter.

The method may further comprises encoding the selected one of the at least one first direct-to-total ratio parameter and the diffuse-energy compensated direct-to-total ratio parameter.

The method may further comprises merging the first audio stream and the second audio stream.

According to a third aspect there is provided an apparatus comprising at least one processor and at least one memory storing instructions that, when executed by the at least one processor, cause the system at least to perform: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

The apparatus caused to perform selecting based on a comparison of the at least one first weighting value and the second weighting value one of the at least one first direct-to-total ratio parameter and the diffuse-energy compensated direct-to-total ratio parameter may be further caused to perform: selecting one of the at least one first direct-to-total ratio parameter when the at least one first weighting value is greater than the second weighting value; and selecting the diffuse-energy compensated direct-to-total ratio parameter when the second weighting value is greater than the at least one first weighting value.

The apparatus caused to perform selecting one of the at least one first direct-to-total ratio parameter when the at least one first weighting value is greater than the second weighting value may be when the at least one first weighting value is strictly greater than the second weighting value.

The apparatus caused to perform selecting the diffuse-energy compensated direct-to-total ratio parameter when the second weighting value is greater than the at least one first weighting value may be when the second weighting value is strictly greater than the at least one first weighting value.

The apparatus caused to perform generating the at least one first weighting value based on the at least one first direct-to-total ratio parameter and the first signal energy parameter may be further caused to perform generating the at least one first weighting value based on a multiplication of the at least one first direct-to-total ratio parameter and the first signal energy parameter.

The at least one first direct-to-total ratio may comprise at least two first direct-to-total ratios, wherein the apparatus caused to perform generating the at least one first weighting value based on the at least one first direct-to-total ratio parameter and the first signal energy parameter may be further caused to perform generating first weighting values associated with each of the at least two first direct-to-total ratio parameters.

The apparatus caused to perform generating first weighting values associated with each of the at least two first direct-to-total ratio parameters may be further caused to perform generating each first weighting value based on a multiplication of each of the at least one first direct-to-total ratio parameter and the first signal energy parameter.

The apparatus caused to perform selecting based on a comparison of the at least one first weighting value and the second weighting value one of the at least one first direct-to-total ratio parameter and the diffuse-energy compensated direct-to-total ratio parameter may be further caused to perform: selecting the at least two first direct-to-total ratio parameters when the first weighting values are both greater than the second weighting value; and selecting the diffuse-energy compensated direct-to-total ratio parameter and one of the at least two first direct-to-total ratio parameters when the second weighting value is greater than one of the at least two first weighting values.

The apparatus caused to perform generating a second weighting value based, in part, at least one of: the second direct-to-total ratio parameter; the diffuse-energy compensated direct-to-total ratio parameter; and the second signal energy parameter may be further caused to perform one of: generating the at least one second weighting value based on a multiplication of the at least one second direct-to-total ratio parameter and the second signal energy parameter; generating the at least one second weighting value based on a multiplication of the diffuse-energy compensated direct-to-total ratio parameter and the second signal energy parameter; and generating the at least one second weighting value based on an average of the diffuse-energy compensated direct-to-total ratio parameter and the at least one second direct-to-total ratio parameter multiplied by the second signal energy parameter.

The apparatus caused to perform generating a diffuse-energy compensated direct-to-total ratio parameter may be further caused to perform generating at least one merged diffuse-to-total ratio based at least in part on the first signal energy parameter, the second signal energy parameter and a diffuse signal energy parameter.

The apparatus may be further caused to perform: obtaining, for the first audio stream at least one first diffuse-to-total ratio parameter; and obtaining the diffuse signal energy parameter based, in part, on the first signal energy parameter and the first diffuse-to-total ratio parameter.

The apparatus caused to perform generating a diffuse-energy compensated direct-to-total ratio parameter may be further caused to perform generating the at least one diffuse-energy compensated direct-to-total ratio parameter based on the at least one merged diffuse-to-total ratio.

The apparatus may be further caused to perform obtaining, for the second audio stream at least one second diffuse-to-total ratio parameter, wherein the apparatus caused to perform generating at least one merged diffuse-to-total ratio may be further caused to perform generating the at least one merged diffuse-to-total ratio based on the second diffuse-to-total ratio parameter.

The apparatus caused to perform generating the diffuse-energy compensated direct-to-total ratio parameter may be further caused to perform: generating at least one prospective diffuse-energy compensated direct-to-total ratio parameter based on the at least one merged diffuse-to-total ratio; comparing the at least one prospective diffuse-energy compensated direct-to-total ratio parameter to the second direct-to-total ratio parameter; selecting the diffuse-energy compensated direct-to-total ratio parameter from the at least one prospective diffuse-energy compensated direct-to-total ratio parameter and the second direct-to-total ratio parameter based on the comparing, such that the diffuse-energy compensated direct-to-total ratio parameter is the smaller of the at least one prospective diffuse-energy compensated direct-to-total ratio parameter and the second direct-to-total ratio parameter.

The apparatus may be further caused to perform encoding the selected one of the at least one first direct-to-total ratio parameter and the diffuse-energy compensated direct-to-total ratio parameter.

The apparatus may be further caused to perform merging the first audio stream and the second audio stream.

According to a fourth aspect there is provided an apparatus comprising: obtaining circuitry configured to obtain, for a first audio stream at least one first direct-to-total ratio parameter; obtaining circuitry configured to obtain, for the first audio stream, a first signal energy parameter; generating circuitry configured to generate at least one first weighting value based on the at least one first direct-to-total ratio parameter and the first signal energy parameter; obtaining circuitry configured to obtain, for a second audio stream a second direct-to-total ratio parameter; obtaining circuitry configured to obtain, for the second audio stream a second signal energy parameter; generating circuitry configured to generate a diffuse-energy compensated direct-to-total ratio parameter; generating circuitry configured to generate a second weighting value based on, in part, at least one of: the second direct-to-total ratio parameter; the diffuse-energy compensated direct-to-total ratio parameter; and the second signal energy parameter; and selecting circuitry configured to select based on a comparison of the at least one first weighting value and the second weighting value one of the at least one first direct-to-total ratio parameter and the diffuse-energy compensated direct-to-total ratio parameter.

According to a fifth aspect there is provided a computer program comprising instructions [or a computer readable medium comprising program instructions] for causing an apparatus to perform at least the following: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

According to a sixth aspect there is provided a non-transitory computer readable medium comprising program instructions for causing an apparatus to perform at least the following: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

According to a seventh aspect there is provided an apparatus comprising: means for obtaining, for a first audio stream at least one first direct-to-total ratio parameter; means for obtaining, for the first audio stream, a first signal energy parameter; means for generating at least one first weighting value based on the at least one first direct-to-total ratio parameter and the first signal energy parameter; means for obtaining, for a second audio stream a second direct-to-total ratio parameter; means for obtaining, for the second audio stream a second signal energy parameter; means for generating a diffuse-energy compensated direct-to-total ratio parameter; means for generating a second weighting value based on, in part, at least one of: the second direct-to-total ratio parameter; the diffuse-energy compensated direct-to-total ratio parameter; and the second signal energy parameter; and means for selecting based on a comparison of the at least one first weighting value and the second weighting value one of the at least one first direct-to-total ratio parameter and the diffuse-energy compensated direct-to-total ratio parameter.

According to an eighth aspect there is provided a computer readable medium comprising program instructions for causing an apparatus to perform at least the following: obtaining, for a first audio stream at least one first direct-to-total ratio parameter; obtaining, for the first audio stream, a first signal energy parameter; generating at least one first weighting value based on the at least one first direct-to-total ratio parameter and the first signal energy parameter; obtaining, for a second audio stream a second direct-to-total ratio parameter; obtaining, for the second audio stream a second signal energy parameter; generating a diffuse-energy compensated direct-to-total ratio parameter; generating a second weighting value based on, in part, at least one of: the second direct-to-total ratio parameter; the diffuse-energy compensated direct-to-total ratio parameter; and the second signal energy parameter; and selecting based on a comparison of the at least one first weighting value and the second weighting value one of the at least one first direct-to-total ratio parameter and the diffuse-energy compensated direct-to-total ratio parameter.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an apparatus for MASA metadata extraction;

FIG. 2 shows schematically an example MASA metadata stream merger;

FIG. 3 shows schematically an example MASA stream merger as shown in FIG. 2 in further detail;

FIG. 4 shows schematically an example OMASA stream merger, for merging a MASA stream and ISM stream into a combined stream;

FIG. 5 shows schematically an example system of apparatus suitable for implementing some embodiments;

FIG. 6 shows schematically an example merger suitable for employing as part of the encoder as shown in FIG. 5, configured to implement merging according to some embodiments.

FIG. 7 shows a flow diagram of the operation of the example metadata merger as shown in FIG. 6 according to some embodiments;

FIG. 8 shows schematically an additional example metadata merger suitable for employing as part of the encoder as shown in FIG. 5, configured to implement merging according to some embodiments;

FIG. 9 shows a flow diagram of the operation of the example additional example metadata merger as shown in FIG. 8 according to some embodiments;

FIG. 10 shows schematically another example metadata merger suitable for employing as part of the encoder as shown in FIG. 5, configured to implement merging according to some embodiments;

FIG. 11 shows schematically a multi-directional metadata merger suitable for employing as part of the encoder as shown in FIG. 5, configured to implement merging according to some embodiments; and

FIG. 12 shows an example device suitable for implementing the apparatus shown in previous figures.

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency. It is expected to support channel-based audio, object-based audio, and scene-based audio inputs including spatial information about the sound field and sound sources.

In the following the example codec is configured to be able to receive multiple input formats. In particular the codec is configured to obtain or receive a multi audio signal (for example, received from a microphone array, or as a multichannel audio format input, or an Ambisonics format input) and an audio object signal (these can also be called an Independent Stream with Metadata-ISM format). Furthermore, in some situations the codec is configured to handle more than one input format at a time.

This combined (input) format mode can, for example, enable simultaneous encoding of two different audio input formats. An example of two different audio input formats being currently considered is the combination of the MASA format with audio object format (ISM format).

Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example, a reasonable design choice which is able to produce a good quality output is one where the spatial metadata comprises one or more directions for each time-frequency subframe (and associated with each direction direct-to-total ratios, spread coherence, distance values etc) are determined.

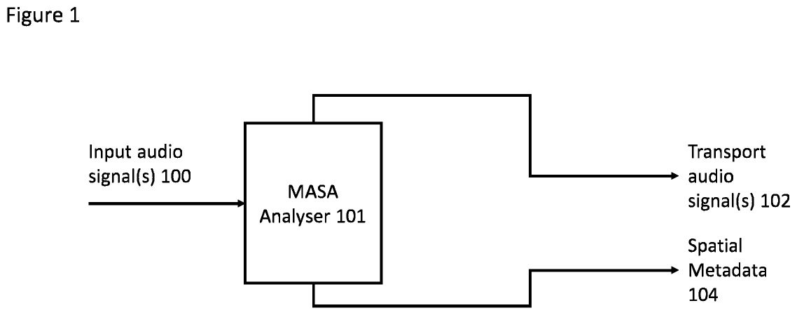

With respect to FIG. 1 is shown an example MASA analyser 101. The MASA analyser 101 is configured to receive the input audio signal(s) 100 and analyse the input audio signals to generate transport audio signal(s) 102 and spatial metadata 104.

Examples of MASA spatial metadata is presented in the following table. These values are available for each time-frequency tile. In some implementations a frame is subdivided into 24 frequency bands and 4 temporal sub-frames. In other implementations other divisions of frequency and time can be employed. Furthermore, in some implementations a frame size (for example as implemented in IVAS) is 20 ms (and thus the temporal sub-frame is 5 ms). However, similarly, other frame lengths can be employed in other embodiments. In some embodiments the MASA analyser is configured to determine 1 or 2 directions for each time-frequency tile (i.e., there are 1 or 2 direction index, direct-to-total energy ratio, and spread coherence parameters for each time-frequency tile). However, in some embodiments the analyser is configured to generate more than 2 directions for a time-frequency tile.

| Field | bits | Description |
|---|---|---|
| Direction | 16 | Direction of arrival of the sound at a time-frequency |
| index | | parameter interval. Spherical representation at about |
| | | 1- degree accuracy. |
| | | Range of values: “covers all directions at about 1° |
| | | accuracy” |
| | | Values stored as 16-bit unsigned integers. |
| Direct-to- | 8 | Energy ratio for the direction index (i.e., time- |
| total | | frequency subframe). |
| energy ratio | | Calculated as energy in direction/total energy. |
| | | Range of values: [0.0, 1.0] |
| | | Values stored as 8-bit unsigned integers with |
| | | uniform spacing of mapped values. |
| Spread | 8 | Spread of energy for the direction index (i.e., time- |
| coherence | | frequency subframe). |
| | | Defines the direction to be reproduced as a point |
| | | source or coherently around the direction. |
| | | Range of values: [0.0, 1.0] |
| | | Values stored as 8-bit unsigned integers with |
| | | uniform spacing of mapped values. |
| Diffuse-to- | 8 | Energy ratio of non-directional sound over |
| total energy | | surrounding directions. |
| ratio | | Calculated as energy of non-directional sound/total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Surround | 8 | Coherence of the non-directional sound over the |
| coherence | | surrounding directions. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Remainder- | 8 | Energy ratio of the remainder (such as microphone |
| to-total | | noise) sound energy to fulfil requirement that sum of |
| energy | | energy ratios is 1. |
| ratio | | Calculated as energy of remainder sound/total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |

The MASA stream can be rendered to various outputs, such as multichannel loudspeaker signals (e.g., 5.1) or binaural signals.

Another input format to be supported by IVAS is, as discussed above, the ISM (Independent Streams with Metadata) format. The ISM format is intended for representing individual sound sources (audio objects) in a sound scene with the associated metadata describing how the rendering of the audio signal may be implemented. This can be contrasted to the MASA format where the audio signals and associated metadata describe perceptually the whole sound scene. Example metadata for the ISM format may comprise the following parameters:
Position (e.g., as azimuth and elevation; or as azimuth, elevation and radius);
Orientation;
Extent/spread;
Distance attenuation; and
Directivity pattern.

In some embodiments some of the example metadata parameters such as the position, orientation, and extent/spread can vary through time but not frequency, whereas some of the parameters, for example, distance attenuation and directivity pattern may vary through frequency but usually do not vary through time. However, the parameters can have time and frequency variances (or invariances) other than the examples above and herein.

In some embodiments an ISM format input can be obtained by capturing individual sources in a scene using, for example, close or lavalier microphones (located on or near to an individual source). Examples of such individual sources are: separate speakers in a teleconference, a singer, or individual instruments. Metadata can then be associated to these ISM format signals automatically by, for example, position trackers, or manually by a mixing professional. Alternatively, ISM format signals may be generated by mixing and creating suitable associated metadata. An example of fully generated sound sources is in game audio engines.

As indicated above research is being carried out into enabling the IVAS codec to support combined coding of multiple audio formats. In many use cases there can be content captured from a sound scene in multiple formats and these can be encoded and transmitted more efficiently by encoding them as a combined format. An example use case of such a situation is a “reporter scene” where a spatial capture is implemented to obtain an overall sound scene and a separate microphone is added for a reporter to optimally capture their voice, thus improving the quality of the full capture. The corresponding captured formats in this example can be a MASA format (from the capture sound scene) and an ISM format (from the reporter). Without combined coding, these formats require separate instances of IVAS codec whereas with combined coding there is only one instance required.

This saves complexity and allows very flexible optimization of bitrate use between different parts (audio and metadata) of the combined format.

This combined format can be referred to as an “Objects and MASA”-format (OMASA), which combines MASA format and ISM format into single combined format.

GB2217905.5 describes bitrate-dependent operation modes of OMASA coding. The following examples feature the lowest bitrate operation modes at which the ISM format input is merged with the MASA format input and where they are encoded as a MASA format stream. However, it would be understood that embodiments can use other modes or can be employed in other OMASA coding situations.

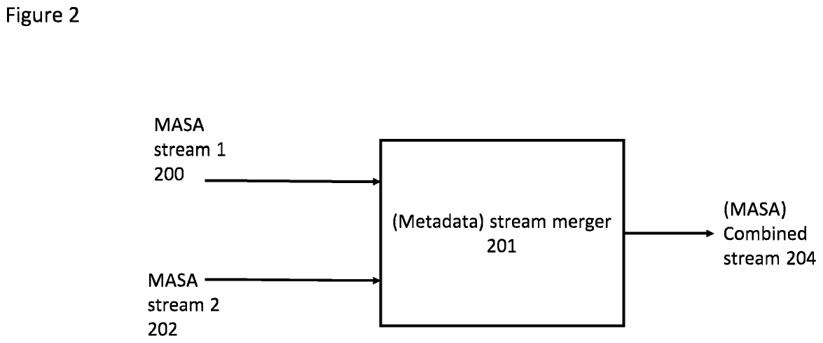

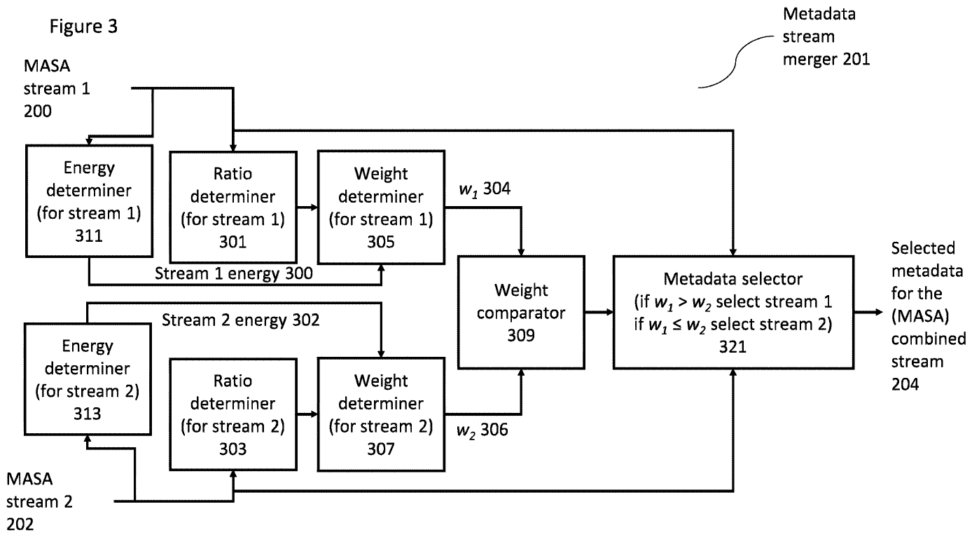

At the lowest bitrates of OMASA-format coding, a format merging method is required to merge the format together into a form more suitable for encoding and transmitting through the tight bitrate limitation. An example merging method has been described in GB2574238. This merging method shows two parametric spatial audio format inputs such as MASA format which are merged into a single output parametric spatial audio format. This is shown, for example, with respect to FIGS. 2 and 3.

FIG. 2 shows (metadata) stream merger 201 which is configured to receive a MASA stream 1 200 and a MASA stream 2 202 and generate a (MASA) combined stream 204. FIG. 3 furthermore shows the example (metadata) stream merger 201 in further detail and with respect to metadata merging. In this example the (metadata) stream merger 201 is configured to receive the MASA stream 1 200 and MASA stream 2 202.

The example (metadata) stream merger 201 comprises an energy determiner (reference 311 for stream 1 and reference 313 for stream 2) which is configured to determine stream 1 energy 300 and stream 2 energy 302. The energy determiner can, for example, compute the energy of the MASA transport signal in each parameter TF-tile (b, s) separately for both MASA format streams:

$${e}_{b , s}^{m} = {\sum }_{k ∈ b} {\sum }_{n ∈ s} {\sum }_{i} {\vert {X}_{i}^{m} ( k , n ) \vert}^{2}$$

Here,

$${X}_{i}^{m} ( k , n )$$

is the CLDFB-domain representation of mth MASA stream in ith transport channel in CLDFB bin k and slot n that are grouped into the parameter band b and sub-frame s. The sub-frame grouping is employed since the values are usually computed per 5 ms (and the CLDFB representation has temporal resolution of 1.25 ms), but in some embodiments can be determined on a per frame basis, in other words, every 20 ms. The indices (b, s) are omitted in the following text for clarity, but the operations are done for each TF-tile. This computation is done for both streams to be merged and are represented by stream 1 energy 300 and stream 2 energy 302.

The example (metadata) stream merger 201 further comprises a ratio determiner (reference 301 for stream 1 and reference 303 for stream 2). The ratio determiner can obtain the ratios from the MASA streams and pass these to the weight determiner.

Furthermore the example (metadata) stream merger 201 can comprise a weight determiner (reference 305 for stream 1 and reference 307 for stream 2). The weight determiner is configured to form comparison weights for both MASA format streams as direct signal energy of MASA which is

$${w}_{m} = {e}_{MASA}^{m , dir} {r}_{MASA}^{m} , where {r}_{MASA}^{m}$$

is the direct-to-total energy ratio of the mth MASA format stream metadata. This produces two weights w₁ 304 and w₂ 306 for each TF-tile. These weights are then passed to the weight comparator 309.

The example (metadata) stream merger 201 further comprises a weight comparator 309 configured to compare the weights for each TF-tile and control a metadata selector 321.

Also the example (metadata) stream merger 201 comprises a metadata selector 321 which is configured to receive the metadata from the MASA streams and the control from the weight comparator 309. The metadata selector 321 can be configured such that

If w₁>w₂ for the TF-tile, then select metadata from MASA stream 1 for that TF-tile.

Otherwise, select metadata from MASA stream 2 for that TF-tile.

The selected metadata can then be output as the merged metadata within the (MASA) combined stream 204. In some situations the comparison “greater than” > is the comparison “greater than or equal to” ≥. This option can be applied throughout the following examples. In some situations the comparison can contain a bias factor (which can be an additive and/or multiplicative factor) configured to bias the decision in a direction.

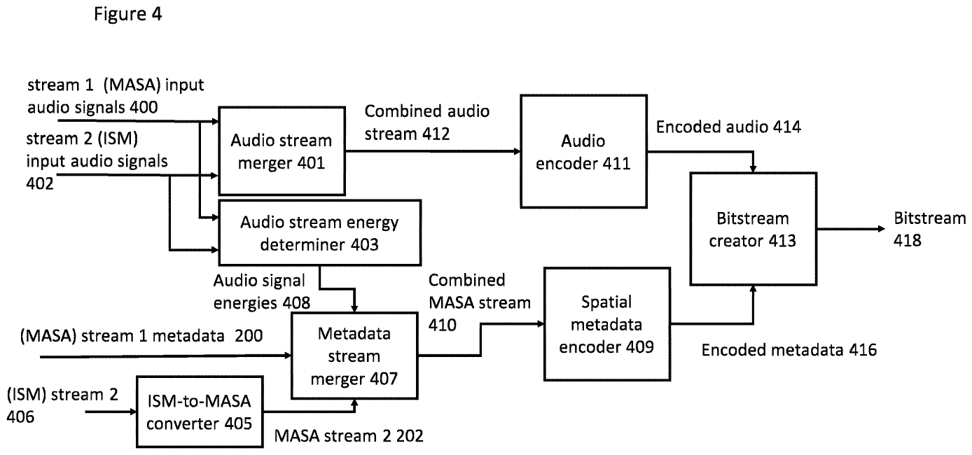

This can be furthermore extended to input formats other than MASA input formats. An example of which is shown in FIG. 4 where an ISM stream and MASA stream are merged and encoded to generate a bitstream.

Thus, for example, FIG. 4 shows a merger/encoder comprising an audio stream merger 401 configured to generate a combined audio stream 412 from the stream 1 (MASA) input audio signals 400 and the stream 2 (ISM) input audio signals 402.

The merger/encoder further comprises an audio stream energy determiner 403 which is configured to determine the audio signal energies 408, for example in a manner similar to that described above with respect to the energy determiner 311, 313 as shown in FIG. 3.

The merger/encoder can comprise an ISM-to-MASA converter 405 which is configured to receive the (ISM) stream 2 406 and generate a MASA stream 2 202. As the metadata of an ISM stream contains values that are compatible with the values of a MASA stream the ISM-to-MASA converter 405 is configured to generate or construct a MASA stream from an ISM stream. In case of a single (active) object, the MASA stream can, for example, be generated by converting the position of an ISM stream into direction of a MASA stream and making the constructed MASA stream completely directional. In other words, assigning direct-to-total ratio value of 1 and diffuse-to-total ratio value of 0 for the constructed MASA format. The definition of the ISM to be a completely directive sound source and assign it with a direct-to-total ratio of 1 and diffuse-to-total ratio of 0 can be justified by the envisioned application in which the ISM is obtained as single audio objects, for example, a lavalier microphone.

In some situations, especially in the case of multiple simultaneous objects in the ISM stream, the converter 405 is configured to convert the ISM into first order Ambisonics (FOA) representations and analyze the source direction from representation. The direct-to-total energy ratio can be obtained by estimating the diffuse-to-total energy ratio of this FOA signal and determining the direct-to-total energy ratio from this. Any other suitable method may be used for converting the ISM stream to a MASA stream (with the above providing two specific examples).

The two MASA format stream metadata can then be merged.

The merger/encoder for example can comprise a metadata stream merger 407 which is configured to receive the (MASA) stream 1 200 and MASA stream 2 202 and from these inputs merge the metadata in a manner similar to that described by the examples shown with respect to FIG. 3. The combined MASA stream 410 generated by the metadata stream merger 407 can then be output to the spatial metadata encoder 409.

The merger/encoder can then comprise a spatial metadata encoder 409 configured to encode the combined MASA stream 410 based on a suitable MASA metadata encoding method and output an encoded metadata to a bitstream creator 413.

The merger/encoder can furthermore comprise a bitstream creator 413 configured to receive the encoded audio 414 from the audio encoder 411 and the encoded metadata 416 from the spatial metadata encoder 409 and generate a bitstream 418 to be output for storage and/or transmission.

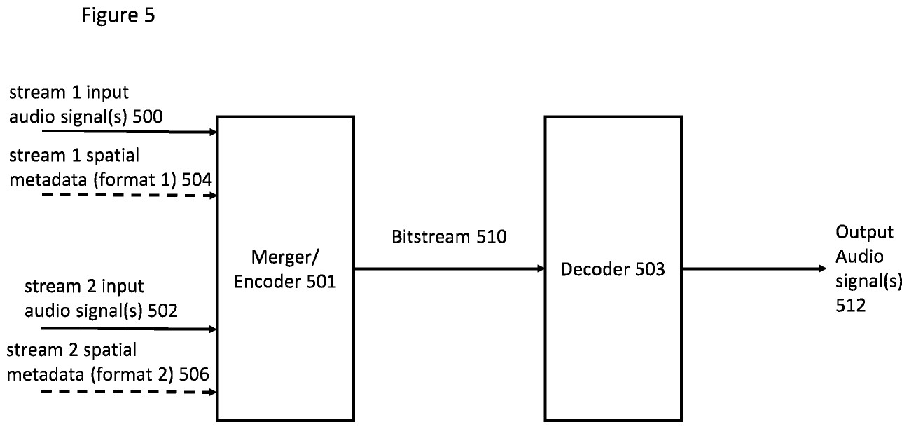

With respect to FIG. 5 is shown an example system of apparatus suitable for implementing some embodiments. The system of apparatus is configured to receive the stream 1 input audio signal(s) 500, stream 1 spatial metadata (in format 1) 504 and stream 2 input audio signal(s) 502, stream 2 spatial metadata (in format 2) 506. These are received by the merger/encoder 501 which is configured to merge the inputs and generate a bitstream 510. The bitstream is then passed to the decoder 503 which then decodes the bitstream and generates the output audio signal(s) 512.

The concept is to improve on the examples above merging MASA streams and MASA streams and ISM-converted-to-MASA streams in general. The above methods can suffer a loss in quality especially when time-frequency resolution and assigned bitrate of the encoded and transmitted merged MASA format is restricted, e.g., 24.4 kbps. Although the loss in quality is more notable at the lowest bitrates, where the time-frequency resolution is low, there can be loss even at higher bitrates, and therefore it is the aim to improve quality for a range of bitrates.

The reason for the loss in quality is that the direct-to-total ratio of close to 1 of the ISM stream combined with usually a significant amount of signal energy emphasizes the presence of the ISM stream in the produced merged and encoded MASA format. This can be perceived as disturbing instability in the reproduced sound scene as the surrounding diffuse sound present in the MASA stream can disappear almost completely when the ISM stream is active. In addition, in some situations, coding artifacts (e.g., heavily quantized directions) are perceived due to the high direct-to-total ratio of the ISM stream as the TF-tiles in the merged stream containing metadata from the ISM stream will get assigned with a higher bit budget than the other TF-tiles in metadata encoding. This can also lead to decreased perceptual quality of the merged stream.

The concept as discussed hereafter with respect to some embodiments and examples is apparatus and methods that aim to preserve the overall diffuse properties of the MASA format source stream in the merged MASA format streams while being able to merge a MASA stream and an ISM-converted-to-MASA stream.

Thus the embodiments and example shown herein relate to merging two parametric spatial audio (i.e., audio signal(s) associated with spatial metadata) streams, where the first stream is a MASA format stream and the second stream is an ISM stream.

The apparatus and methods propose adjusting the merging of the parameters of these two spatial metadata streams such that the perceived overall quality of the merged stream is improved by preserving the MASA format scene envelopment through preserving its diffuse energy.

This can be implemented in the following embodiments and examples by:
obtaining direct-to-total ratios for both streams;
obtaining signal energies for both streams and diffuse energy for the MASA stream;
determining a diffuse-energy compensated direct-to-total ratio parameter:
determining weights for both streams (where the weights can be based on the direct-to-total ratios of the streams and signal energy estimates);
comparing the weights for both streams in each TF-tile;
   and selecting the metadata to use for each TF-tile of the merged MASA stream based on the comparison. The selection can be “MASA stream” parameters for the TF-tile in the MASA stream where the MASA stream related weights are greater than the ISM stream related weights, a diffuse-energy-compensated ISM stream parameters where the ISM stream related weights are greater than the MASA ones, or a selection of the MASA stream and diffuse-energy-compensated ISM stream parameters for the TF-tile based of the value of the ISM stream related weights being greater than at least one of the more than one MASA stream related weight.

In the following disclosure it would be understood that the terms weight(s) and weighting values are interchangeable.

As such the apparatus and method aim to provide improved merging. Although the examples presented herein are two parametric spatial audio streams when one of the streams is originally an ISM stream, i.e., one or more independent audio objects, and the other stream is a MASA format stream (or any similar parametric format), in some embodiments other stream formats can be merged based on the examples presented herein and without significant inventive adjustment. Where the metadata of one input format data stream shows similar properties as the ISM stream, in other words having high directivity and low diffuseness, then this input format stream is particularly suitable for merging using the examples described herein.

In some embodiments the apparatus and methods as described herein can be implemented within a communication codec encoder such as 3GPP IVAS and a combined format coding can be applied at a low bitrate where full merging of the separate format streams is required for a good quality transmission.

The embodiments as described herein can furthermore be implemented as part of a merger/encoder 501 such as shown in FIG. 5. Thus, in some embodiments the apparatus is configured to receive as inputs two streams of parametric spatial audio (“Stream 1” and “Stream 2”). Each of the input streams contains audio signal(s)+metadata (“Stream 1 input audio signal(s)”, “Stream 1 spatial metadata (format 1)”, “Stream 2 input audio signal(s)”, “Stream 2 spatial metadata (format 2)”).

In this example, the streams are a MASA format stream and an ISM stream. In some embodiments, the merger/encoder may contain a pre-processor which converts captured audio signals into MASA format streams and ISM streams. The input streams are given to an encoder which quantizes and encodes the formats into a single bitstream. This bitstream is transmitted to a decoder which in turn decodes the bitstream and produces the output audio signal(s), or some embodiments, an output format (e.g., MASA format).

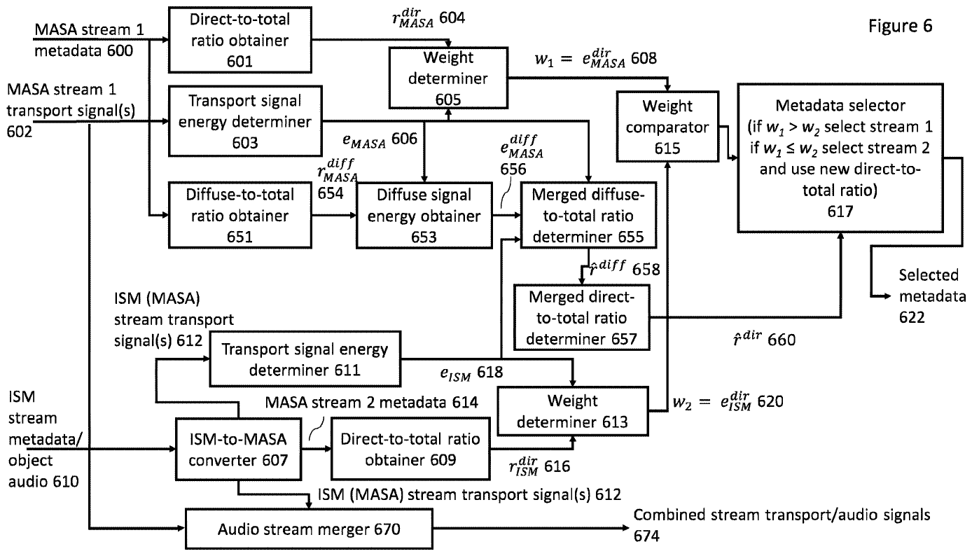

An example merger, shown in FIG. 6, is suitable for implementing within the merger/encoder of FIG. 5 the metadata merging operations. In these embodiments the merging or combining of audio signals and metadata is implemented using different methods. The combining or merging of the audio signals can be implemented using any suitable manner. For example, by mixing the input audio signals together to provide merged audio signals that are then encoded. As such the merging or combining of the audio signals is not described in further detail.

The (metadata) merger or combiner according to some embodiments is shown in FIG. 6.

The merger is configured to receive the MASA stream 1 metadata 600, MASA stream 1 transport signal(s) 602, and ISM stream metadata/object audio 610.

The merger in some embodiments comprises an ISM-to-MASA converter 607. The ISM-to-MASA converter 607 is configured to receive the ISM stream metadata/object audio 610 and generate the MASA stream 2 metadata 614, and the ISM (MASA) stream transport signal(s) 612. This can be implemented by any suitable manner, for example, by assigning the value of the direction parameter of the ISM stream to a direction parameter of MASA format metadata for all frequency bands, and making direct-to-total ratio and diffuse-to-total ratios of MASA format metadata as 1 and 0 constantly (or converting the audio signals into FOA representation and estimating the parameters from this, as described above). The MASA stream 2 metadata 614 is passed to the direct-to-total ratio obtainer 609. The ISM (MASA) stream transport signal(s) 612 is passed to the transport signal energy determiner 611 and to the audio stream merger 670.

The merger comprises a direct-to-total ratio obtainer 601 which is configured to obtain the MASA stream 1 metadata 600 and extract or otherwise obtain the MASA ratio

$${r}_{MASA}^{dir}$$

604 which is output to the weight determiner 605.

The metadata merger comprises a direct-to-total ratio obtainer 609 which is configured to obtain the MASA stream 2 metadata 614 and extract or otherwise obtain the ISM based ratio

$${r}_{ISM}^{dir}$$

616 which is output to the weight determiner 613.

Additionally the metadata merger comprises a transport signal energy determiner 603 which is configured to estimate the energy of the MASA transport signal in each parameter TF-tile:

$${e}_{MASA}^{b , s} = {\sum }_{k ∈ b} {\sum }_{n ∈ s} {\sum }_{i} {\vert {X}_{i} ( k , n ) \vert}^{2}$$

Here, Xᵢ(k, n) is the CLDFB-domain representation of ith transport channel in CLDFB bin k and slot n that are grouped into the parameter band b and frame s. Hereafter, the indices (b, s) are omitted for clarity, but the operations are done for each TF-tile. The output e_{MASA} 606 is output to the weight determiner 605, the diffuse signal energy obtainer 653 and merged diffuse-to-total ratio determiner 655.

The merger comprises a further transport signal energy determiner 611 is configured to compute a transport signal energy estimate for the ISM transport signal 612 in each parameter TF-tile:

$${e}_{ISM}^{b , s} = {\sum }_{k ∈ b} {\sum }_{n ∈ s} {\sum }_{i} {\vert {Y}_{i} ( k , n ) \vert}^{2}$$

Here, Yᵢ(k, n) is the CLDFB-domain representation of ith channel of the ISM transport signal. (The indices (b, s) are hereafter omitted for clarity, but the operations are done for each TF-tile). The energy of the ISM transport signal e_{ISM} 618 is which is output to the weight determiner 613 and the merged diffuse-to-total ratio determiner 655.

The merger further comprises a diffuse-to-total ratio obtainer 651 which is configured to obtain or extract the diffuse-to-total ratio

$${r}_{MASA}^{diff}$$

654 from the MASA stream 1 metadata 600.

The merger further comprises a diffuse signal energy obtainer 653 is configured to obtain the diffuse-to-total ratio

$${r}_{MASA}^{diff}$$

654 and the energy of the MASA transport signal in each parameter TF-tile e_{MASA} 606 and generate a diffuse energy value

$${e}_{MASA}^{diff}$$

656. In some embodiments the diffuse signal energy is determined based on the following

$${e}_{MASA}^{diff} = {r}_{MASA}^{diff} {e}_{MASA} .$$

The merger comprises a merged diffuse-to-total ratio determiner 655 which is configured to compute a merged diffuse-to-total ratio of the merged MASA stream 1 and ISM stream with:

$${\hat{r}}^{diff} = \frac{{e}_{MASA}^{diff}}{{e}_{MASA} + {e}_{ISM}}$$

This value describes the amount of diffuse energy in the signal after merging the two streams. The diffuse signal energy \hat{r}^{diff} 658 is passed to a merged direct-to-total ratio determiner 657.

The data merger also comprises a merged direct-to-total ratio determiner 657. This can be implemented by \hat{r}^{dir}=1−\hat{r}^{diff} 660 and this value can be used as the modified direct-to-total energy ratio parameter for the tiles in which the metadata from MASA stream 2 is selected.

The metadata merger comprises a weight determiner 605 configured to use the direct-to-total energy ratios and the transport signal energies for determining comparison weights for the MASA format streams as direct signal energy of MASA which can be

$${w}_{1} = {e}_{MASA}^{dir} = {r}_{MASA} {e}_{MASA} ,$$

608 where r_{MASA} is the direct-to-total energy ratio of the MASA format stream metadata.

The metadata merger comprises a further weight determiner 613 configured to use the direct-to-total energy ratios and the transport signal energies originating from the ISM stream for determining comparison weights for the ISM stream. This weight can be similarly

$${w}_{2} = {e}_{ISM}^{dir} = {r}_{ISM} {e}_{ISM} 620.$$

Thus, the two weights w₁ and w₂ for each TF-tile are passed to the weight comparator 615.

The metadata merger comprises a weight comparator 615 configured to compare the weights and generate a selection control to the metadata selector 617.

The metadata merger furthermore comprises a metadata selector 617 configured to select and output selected metadata 622 based on the selection control from the weight comparator.

For example, the selector can be configured to implement the following selection operations:
If w₁>w₂ for the TF-tile, then select metadata from MASA stream 1 600 for that TF-tile;
Otherwise, select metadata from MASA stream 2 614 (in other words, the metadata from the original “ISM stream”) for that TF-tile and use the new direct-to-total ratio \hat{r}^{dir} 660. In other words, the determined new direct-to-total ratio \hat{r}^{dir} 660 from the Merged direct-to-total ratio determiner 657 is selected (and effectively has replaced the possible selection of the original direct-to-total ratio

$${r}_{ISM}^{dir}$$

616 of the ISM stream).

Additionally in some embodiments the merger comprises an audio stream merger 670 configured to receive the MASA stream 2 transport/audio signals 664 from the ISM-to-MASA converter 607 and the MASA stream 1 transport signal(s) 602 and from these generate a combined stream transport/audio signals 674 which can be output to the suitable audio encoder.

The merged metadata 622 can then be passed to a suitable spatial metadata encoder and the result can be multiplexed together with the audio signals, for example, within a suitable bitstream creator to provide the encoded bitstream which can be transmitted to decoder (or stored for later decoding). The operations of the decoder are not discussed in further detail as the decoding of the bitstream and decoder itself can be implemented using any suitable decoder. In other words, no changes are required there to support the merged MASA stream. Thus, in summary the decoder demultiplexes and decodes the bitstream into audio channels and metadata which are then either output as a MASA format or passed to a renderer which renders them into various output audio signals. These signals can be binaural, loudspeakers, Ambisonics, or any other format.

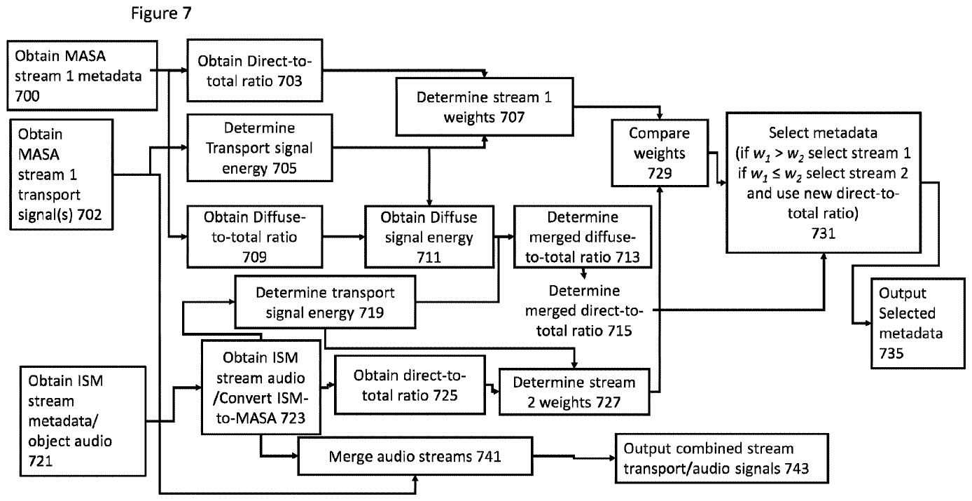

With respect to FIG. 7 is shown an example flow diagram of the operations shown in FIG. 6.

Thus is shown obtaining MASA stream 1 metadata as indicated by 700.

Further is shown obtaining MASA stream 1 transport signal(s) by 702.

Additionally is shown obtaining ISM stream metadata/object audio by 721.

The obtaining of the Direct-to-total ratio from the MASA stream 1 metadata is shown by 703.

The determining of the transport signal energy from the MASA stream 1 transport signal(s) is shown by 705.

The obtaining of the Diffuse-to-total ratio from the MASA stream 1 metadata is shown by 709.

The obtaining of the diffuse signal energy from the diffuse-to-total ratio and transport signal energy is shown by 711.

The determining of stream 1 weights from the direct-to-total ratio and transport signal energy is shown by 707.

The conversion of the ISM-to-MASA metadata and obtaining ISM stream (or MASA stream 2) audio is shown by 723.

The obtaining of the direct-to-total ratio from the converted MASA metadata is shown by 725.

The determining of transport signal energy from the ISM stream transport signal(s) is shown by 719.

The determining of stream 2 weights from the direct-to-total ratio and transport signal energy (for the original ISM stream) is shown by 727.

The determining of a merged diffuse-to-total ratio is shown by 713.

Then the determining of the merged direct-to-total ratio from the merged-to-total ratio is shown by 715.

The comparison of the weights is shown by 729.

Then the selection of the metadata is shown based on the comparison is shown by 731.

The outputting of the selected metadata is shown by 735.

Additionally is shown the merging of the audio streams as shown by 741.

Then the combined or merged audio stream is output as shown by 743.

This implementation aims to take better into account the overall diffuse energy of the MASA format which is important for conveying the perceptual envelopment of the sound scene. This aims to improve the known merging methods, when the metadata from the ISM format stream would be selected for use in a TF-tile, it would also often completely remove (or severely reduce) diffuse energy for that tile. The embodiments thus adjust the amount of diffuse energy by taking into account the increased total energy from the ISM stream. As ISM stream energy is assumed to be dominantly direct, it will decrease diffuse energy for the tile but only by proportion of relative stream energies. This aims to significantly improve a quality of the merged stream as the diffuse field perception is preserved better.

Although, these example embodiments aim to provide a significant quality improvement, the decision criteria and/or the determined ratio values for the merged stream metadata may be further adjusted in some alternative embodiments in an attempt to further improve the quality. These further embodiments are discussed in the following. It should also be noted that these improvements can also be used together. For example, it may be possible to apply the improvement of the two following examples in some embodiments.

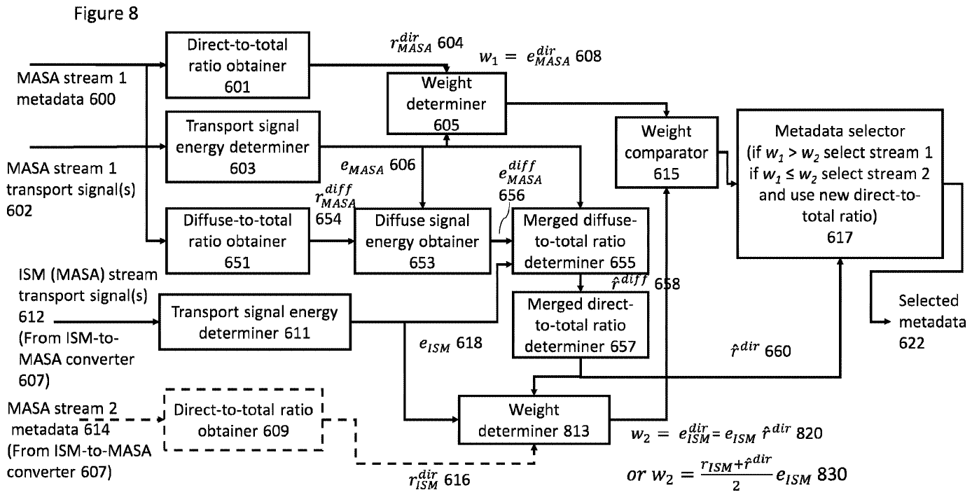

In some embodiments, such as shown in FIG. 8, the comparison weight for stream 2 w₂ (the MASA stream formed from ISM stream) is determined based on the merged direct-to-total energy ratio as w₂=\hat{r}^{dir} e_{ISM}. The difference from the earlier described embodiment is that a slightly different weight is used for the stream decision, but when the decision is the same, the resulting metadata will be the same, too.

Thus the example embodiment as shown in FIG. 8 differs from the embodiment shown in FIG. 6 in that the weight determiner 813 generates the comparison weight for stream 2 based on

$${w}_{2} = {e}_{ISM}^{dir} = {e}_{ISM} {\hat{r}}^{dir}$$

820 which is passed to the weight comparator 615.

In some embodiments the weight determiner 813 is configured to determine an average of the two direct-to-total ratios r_{ISM}, \hat{r}^{dir}. This is shown in FIG. 8 by the dashed line elements of the MASA stream 2 metadata 614 which is processed by the direct-to-total ratio determiner 609 which outputs the ISM direct-to-total ratio r_{ISM} to the weight determiner 813. Thus the ‘average’ based weight 830 can be determined as

$${w}_{2} = \frac{{r}_{ISM} + {\hat{r}}^{dir}}{2} {e}_{ISM}$$

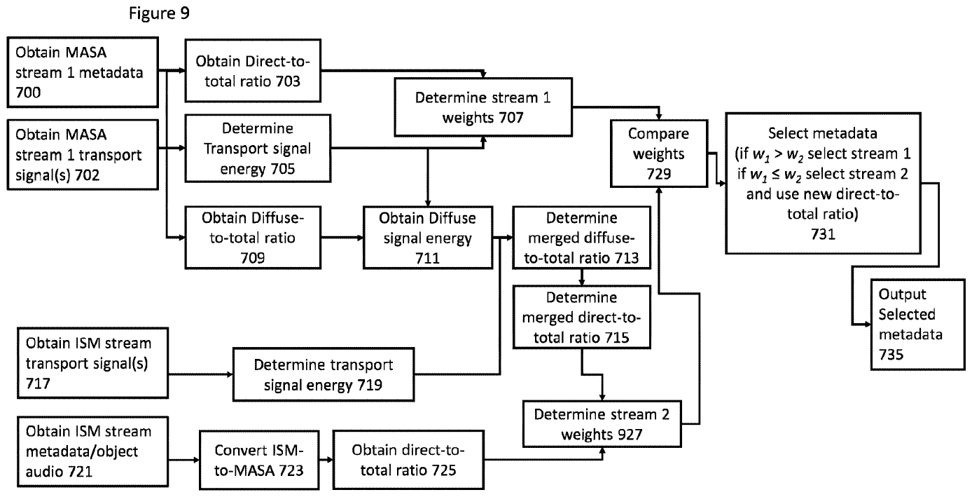

FIG. 9 shows a flow diagram showing the operations of FIG. 8 example apparatus which differs from FIG. 7 in that the operation of determining the stream 2 weights differs in the elements used to generate the weight as shown by 927.

The difference to the example shown with respect to FIGS. 6 and 8 is that a (slightly) different weight is used for the stream decision. However, when the decision is the same, the resulting selected metadata will also be the same, too. In practice, using these adjusted decision criteria can preserve the sound scene stability and further preserve the experience of spaciousness in the scene, as the MASA stream is selected more often, especially in case when the ISM stream contains ratios close to 1.

In some embodiments the conversion from ISM to MASA representation can be implemented by assuming that the signal energy is completely directional assigning the direct-to-total energy ratio to 1. While this is true in some situations, it is possible to do the conversion using other methods, for example, using a FOA representation. In such embodiments it is possible that the ISM contains some amount of diffuse energy. Another example situation where non-negligible diffuse-to-total energy ratio may be present in the ISM stream is when two or more ISM objects are active in the same TF-tile, leading to a direct-to-total energy ratio that may be significantly smaller than 1. Such a parametrization may be desirable for a more realistic perception of space in the reproduction.

If the amount of the diffuse energy in the ISM is non-negligible, it may be useful to take this diffuse energy into account. Otherwise, the ratio values may unintentionally be increased for TF tiles in which the ISM metadata was selected to be used but the MASA stream had less diffuse energy than the ISM stream. This may be perceived as losing spaciousness in the merged stream.

The accounting for the diffuse energy can employ many forms. For example, the resulting direct-to-total energy ratio fair may be limited to not be larger than the original direct-to-total energy ratio, in case the ISM metadata was selected for the TF tile, i.e.,

\hat{r}^{dir,mod}=min(\hat{r}^{dir},r_{ISM})

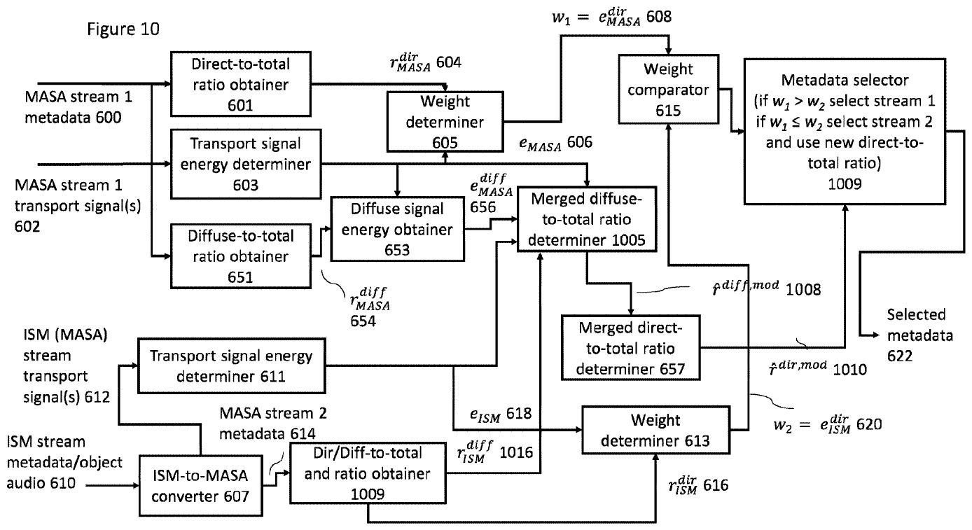

A further example, based on the example shown in FIG. 6, but accounting for the diffuse energy is shown with respect to FIG. 10 where the merged diffuse-to-total ratio determiner 1005 is modified by

$${\hat{r}}^{diff , mod} = \frac{{e}_{MASA}^{diff} + {e}_{ISM}^{diff}}{{e}_{MASA} + {e}_{ISM}}$$

where

$${e}_{ISM}^{diff} = {r}_{ISM}^{diff} {e}_{ISM}$$

describes the amount of diffuse energy in the ISM stream. The \hat{r}^{diff,mod} 1008 is then passed to the merged direct-to-total ratio determiner 707 to determine the direct-to-total energy ratio of the merged stream \hat{r}^{dir,mod}=1−\hat{r}^{diff,mod}. The modified direct-to-total energy ratio \hat{r}^{dir,mod} 1010 is then passed to the metadata selector 709.

Furthermore is shown in FIG. 10 is shown the direct-to-total/diffuse-to-total ratio obtainer 1009 configured to obtain not only the direct-to-total ratio but also the diffuse-to-total ratio

$${r}_{ISM}^{diff}$$

1016 which is passed to the merged diffuse-to-total ratio determiner 1005.

Although this example is based on the example shown in FIG. 6 a similar modification to the merged diffuse-to-total ratio determination can be implemented with respect to the example embodiment shown in FIG. 8.

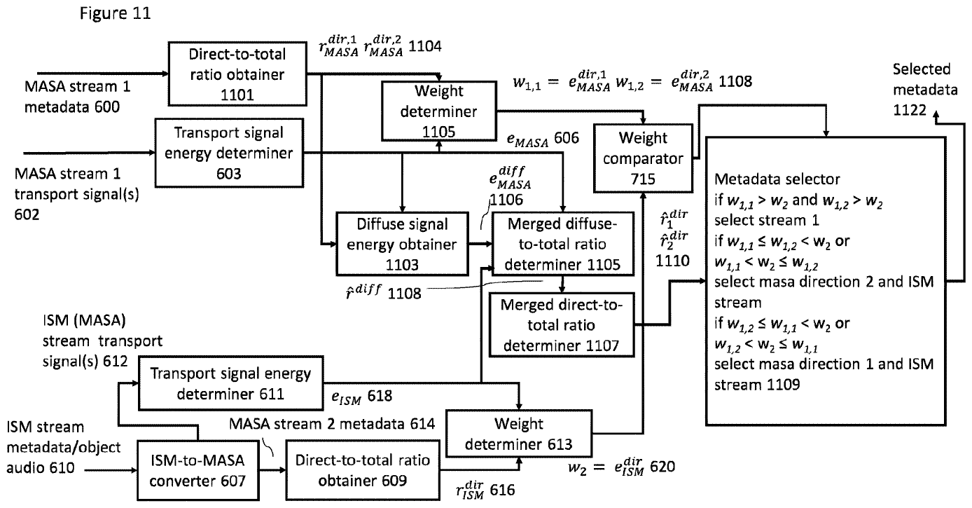

With respect to FIG. 11 is shown a further example where there are 2 simultaneous directions. This can be further extended to higher number of directional fields.

Thus the direct-to-total ratio obtainer 1101 is configured to obtain two direct-to-total energy ratios

$${r}_{1}^{dir}$$

and

$${r}_{2}^{dir}$$

in the original MASA metadata stream, one for each direction and which are also designated

$${r}_{MASA}^{dir , 1} {r}_{MASA}^{dir , 2}$$

1104.

The weight determiner 1105 is configured to determine absolute direct energies for both directions are computed with

$${e}_{MASA}^{dir , 1} = {r}_{MASA}^{dir , 1} {e}_{MASA} and {e}_{MASA}^{dir , 2} = {r}_{MASA}^{dir , 2} {e}_{MASA} .$$

These are used as additional weight terms instead of the earlier w₁:

$${w}_{1 , 1} = {e}_{MASA}^{dir , 1} and {w}_{1 , 2} = {e}_{MASA}^{dir , 2}$$

The weights are compared in the weight comparator 715 and then selected by the metadata selector based on:
If w_{1,1}>w₂ and w_{1,2}>w₂, use the “MASA stream 1” parameters;
If w_{1,1}≤w_{1,2}<w₂ or w_{1,1}<w₂≤w_{1,2}, use parameters from “MASA direction 2” and “ISM stream”.

If w_{1,2}≤w_{1,1}<w₂ or w_{1,2}<w₂≤w_{1,1}, use the parameters from “MASA direction 1” and “ISM stream”.

In some embodiments this can extended by the diffuse signal energy obtainer 1103 being configured to determine the MASA's diffuse signal energy

$${e}_{MASA}^{diff}$$

1106 with

$${e}_{MASA}^{diff} = ( 1 - {r}_{MASA , 1} - {r}_{MASA , 2} ) {e}_{MASA} = {e}_{MASA} - {e}_{MASA}^{dir , 1} - {E}_{MASA}^{dir , 2} .$$

Furthermore the merged diffuse-to-total ratio determiner 1105 is configured to determine a diffuse-to-total energy ratio of the combined signal \hat{r}^{diff} 1108 with

$${\hat{r}}^{diff} = \frac{{e}_{MASA}^{diff}}{{e}_{MASA} + {e}_{ISM}}$$

Additionally the merged direct-to-total ratio determiner 1107 is then configured to scale the newly-assigned direct-to-total energy ratios

$${r}_{1}^{dir} ,$$

depending on this new diffuse-to-total energy ratio with

$${\hat{r}}_{1}^{dir} = \frac{{r}_{1}^{dir}}{{r}_{1}^{dir} + {r}_{2}^{dir} + {\hat{r}}^{diff}}$$

and

$${\hat{r}}_{2}^{dir} = \frac{{r}_{2}^{dir}}{{r}_{1}^{dir} + {r}_{2}^{dir} + {\hat{r}}^{diff}}$$

Similar as with the previous examples, this two-direction embodiment can be extended to include the diffuse energy of the ISM-objects too in a manner similar to the embodiment described in FIGS. 8 and 10.

In some embodiments the merging or combining of metadata is selected based on a determining of a measure of “object-likeness” from the spatial metadata of the streams to be merged. In other words, a weight is determined based on an object-likeness parameter.

In such embodiments where both streams have low object-likeness, e.g., they contain a non-negligible amount of diffuse energy, then the merging method as shown in FIG. 6 is implemented.

If both streams have high object-likeness, e.g., both have a negligible amount of diffuse energy, then the merging method as shown in FIG. 6 is implemented.

If one stream has a low object-likeness and one stream has a high object-likeness then the merging method as shown in embodiments shown in any of FIGS. 9 onwards or described above can be implemented.

In some embodiments the “object-likeness” parameter can be determined by inspecting the overall diffuse energy (objects are usually highly directive with minimal or no diffuse part) and inspecting direction variation over frequency as there usually is no variation over frequency with objects.

In some embodiments an extension of the example embodiments described above can be extend them by using the modified direct-to-total energy ratio \hat{r}^{dir}=1−\hat{r}^{diff} also in the case the metadata from “MASA stream 1” is selected. In practice, the direct-to-total ratio will be the same regardless of the selection made whereas the other parameters will be selected from one stream or another.

The entire description above is describing the case of merging two streams. In the case of three or more streams to be merged, the approach can be extended in a straightforward manner, for example, by merging streams repeatedly in pairs (or in a cascade) until the desired number of streams is remaining, or by extending the method above to include weights for all streams simultaneously and selecting the metadata of the stream with the highest weight.

In the examples shown above Complex-Values Low-Delay Filter Bank (CLDFB) as the frequency-domain representation other methods of time-frequency domain representation can be employed such as Short-time Fourier Transform (STFT) or Quadrature Mirrored Filterbank (QMF).

The parametric format described above has been MASA format but the embodiments can be extended to other parametric formats such as parametric coding of Ambisonics or multi-channel mixes.

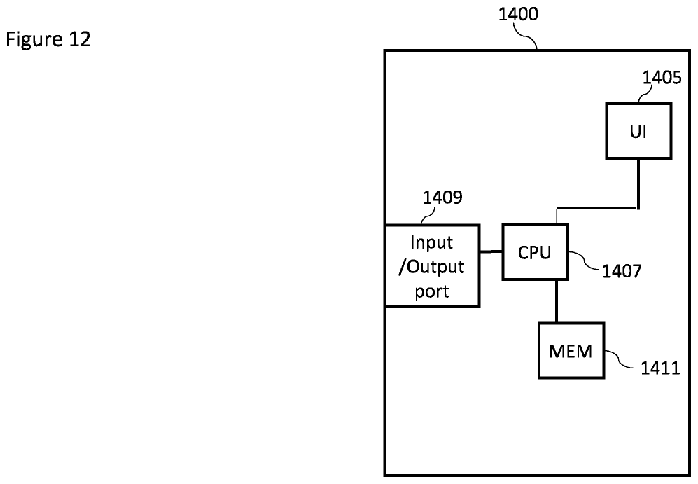

With respect to FIG. 12 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder and/or decoder or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example, the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example, in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.
   This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor and at least one memory storing instructions that, when executed by the at least one processor, are for causing the apparatus to perform at least the following:
obtaining, for a first audio stream at least one first direct-to-total energy ratio parameter;
obtaining, for the first audio stream, a first signal energy parameter;
obtaining, for the first audio stream, a first diffuse-to-total energy ratio parameter;
generating at least one first weighting value based on the at least one first direct-to-total energy ratio parameter and the first signal energy parameter;
obtaining, for a second audio stream a second direct-to-total energy ratio parameter;
obtaining, for the second audio stream a second signal energy parameter;
generating a diffuse-energy compensated direct-to-total energy ratio parameter;
based on the first signal energy parameter, the second signal energy parameter and the first diffuse-to-total energy ratio parameter;
generating a second weighting value based on:
the second direct-to-total ratio parameter,
the diffuse-energy compensated direct-to-total ratio parameter, and
the second signal energy parameter; and
selecting, based on a comparison of the at least one first weighting value and the second weighting value, one of the at least one first direct-to-total energy ratio parameter or the diffuse-energy compensated direct-to-total energy ratio parameter.

2. The apparatus as claimed in claim 1, wherein the instructions for selecting, based on a comparison of the at least one first weighting value and the second weighting value, one of the at least one first direct-to-total ratio energy parameter or the diffuse-energy compensated direct-to-total energy ratio parameter are further for:
selecting one of the at least one first direct-to-total energy ratio parameter when the at least one first weighting value is greater than the second weighting value; and
selecting the diffuse-energy compensated direct-to-total energy ratio parameter when the second weighting value is greater than the at least one first weighting value.

3. The apparatus as claimed in claim 2, wherein the instructions for selecting one of the at least one first direct-to-total energy ratio parameter when the at least one first weighting value is greater than the second weighting value is when the at least one first weighting value is strictly greater than the second weighting value.

4. The apparatus as claimed in claim 2, wherein the instructions for selecting the diffuse-energy compensated direct-to-total energy ratio parameter when the second weighting value is greater than the at least one first weighting value is when the second weighting value is strictly greater than the at least one first weighting value.

5. The apparatus as claimed in claim 1, wherein the instructions for generating the at least one first weighting value based on the at least one first direct-to-total energy ratio parameter and the first signal energy parameter are for generating the at least one first weighting value based on a multiplication of the at least one first direct-to-total energy ratio parameter and the first signal energy parameter.

6. The apparatus as claimed in claim 1, wherein the at least one first direct-to-total energy ratio parameter comprises at least two first direct-to-total energy ratio parameters, wherein the instructions for generating the at least one first weighting value based on the at least one first direct-to-total energy ratio parameter and the first signal energy parameter is for generating first weighting values associated with each of the at least two first direct-to-total energy ratio parameters.

7. The apparatus as claimed in claim 6, wherein the instructions for generating first weighting values associated with each of the at least two first direct-to-total energy ratio parameters is are for generating each first weighting value based on a multiplication of each of the at least one first direct-to-total energy ratio parameter and the first signal energy parameter.

8. The apparatus as claimed in claim 6, wherein the instructions for selecting, based on a comparison of the at least one first weighting value and the second weighting value, one of the at least one first direct-to-total energy ratio parameter and the diffuse-energy compensated direct-to-total energy ratio parameter are further for:
selecting the at least two first direct-to-total energy ratio parameters when the first weighting values are both greater than the second weighting value; and
selecting the diffuse-energy compensated direct-to-total energy ratio parameter and one of the at least two first direct-to-total energy ratio parameters when the second weighting value is greater than one of the at least two first weighting values.

9. The apparatus as claimed in claim 1, wherein the instructions for generating a second weighting value based on the second direct-to-total energy ratio parameter, the diffuse-energy compensated direct-to-total energy ratio parameter; and the second signal energy parameter are further for causing the apparatus to perform:
generating the at least one second weighting value based on an average of the diffuse-energy compensated direct-to-total energy ratio parameter and the at least one second direct-to-total energy ratio parameter multiplied by the second signal energy parameter.

10. The apparatus as claimed in claim 1, wherein the instructions for generating the diffuse-energy compensated direct-to-total energy ratio parameter by calculating 1−(X/Y), wherein X is a product of the first diffuse-to-total energy ratio parameter and the first signal energy parameter, and wherein Y is a sum of the first signal energy parameter and the second signal energy parameter.

11. (canceled)

12. The apparatus as claimed in claim 10, wherein the diffuse-energy compensated direct-to-total energy ratio parameter is limited to not be larger than the second direct-to-total parameter.

13. (canceled)

14. The apparatus as claimed in claim 12, wherein the diffuse-energy compensated direct-to-total energy ratio parameter is determined using the function min(diffuse-energy compensated direct-to-total energy ratio parameter, second direct-to-total energy ratio parameter).

15. The apparatus as claimed in claim 1, wherein the instructions, when executed by the at least one processor, are further for causing the apparatus to encode the selected one of the at least one first direct-to-total energy ratio parameter and the diffuse-energy compensated direct-to-total energy ratio parameter.

16. The apparatus as claimed in claim 1, wherein the instructions, when executed by the at least one processor, are further for causing the apparatus to merge the first audio stream and the second audio stream.

17. A method comprising:
obtaining, for a first audio stream at least one first direct-to-total energy ratio parameter;
obtaining, for the first audio stream, a first signal energy parameter;
obtaining, for the first audio stream, a first diffuse-to-total energy ratio parameter;
generating at least one first weighting value based on the at least one first direct-to-total energy ratio parameter and the first signal energy parameter;
obtaining, for a second audio stream a second direct-to-total energy ratio parameter;
obtaining, for the second audio stream a second signal energy parameter;
generating a diffuse-energy compensated direct-to-total energy ratio parameter based on the first signal energy parameter, the second signal energy parameter and the first diffuse-to-total energy ratio parameter;
generating a second weighting value based on:
the second direct-to-total ratio parameter,
the diffuse-energy compensated direct-to-total ratio parameter, and
the second signal energy parameter; and
selecting, based on a comparison of the at least one first weighting value and the second weighting value, one of the at least one first direct-to-total energy ratio parameter or the diffuse-energy compensated direct-to-total energy ratio parameter.

18. The method as claimed in claim 17, wherein selecting, based on a comparison of the at least one first weighting value and the second weighting value, one of the at least one first direct-to-total energy ratio parameter or the diffuse-energy compensated direct-to-total energy ratio parameter further comprises:
selecting one of the at least one first direct-to-total energy ratio parameter when the at least one first weighting value is greater than the second weighting value; and
selecting the diffuse-energy compensated direct-to-total energy ratio parameter when the second weighting value is greater than the at least one first weighting value.

19. (canceled)

20. (canceled)

21. The method as claimed claim 17, wherein generating the at least one first weighting value based on the at least one first direct-to-total energy ratio parameter and the first signal energy parameter further comprises generating the at least one first weighting value based on a multiplication of the at least one first direct-to-total energy ratio parameter and the first signal energy parameter.

22. (canceled)

23. The method as claimed in claim 15, wherein generating a second weighting value based on the second direct-to-total energy ratio parameter, the diffuse-energy compensate direct-to-total energy ratio parameter, and the first signal energy parameter further comprises:
generating the at least one second weighting value based on an average of the diffuse-energy compensated direct-to-total energy ratio parameter and the at least one second direct-to-total energy ratio parameter multiplied by the second signal energy parameter.

24. (canceled)

25. (canceled)

26. The method as claimed in claim 17 wherein generating a diffuse-energy compensated direct-to-total energy ratio parameter further comprises generating the diffuse-energy compensated direct-to-total energy ratio parameter by calculating 1−(X/Y), wherein X is a product of the first diffuse-to-total energy ratio parameter and the first signal energy parameter, and wherein Y is a sum of the first signal energy parameter and the second signal energy parameter.

27-32. (canceled)

33. A non-transitory computer-readable storage medium comprising program instructions for causing an apparatus to perform at least the following:
obtaining, for a first audio stream at least one first direct-to-total energy ratio parameter;
obtaining, for the first audio stream, a first signal energy parameter;
obtaining, for the first audio stream, a first diffuse-to-total energy ratio parameter;
generating at least one first weighting value based on the at least one first direct-to-total energy ratio parameter and the first signal energy parameter;
obtaining, for a second audio stream a second direct-to-total energy ratio parameter;
obtaining, for the second audio stream a second signal energy parameter;
generating a diffuse-energy compensated direct-to-total energy ratio parameter based on the first signal energy parameter, the second signal energy parameter and the first diffuse-to-total energy ratio parameter;
generating a second weighting value based on:
the second direct-to-total ratio parameter,
the diffuse-energy compensated direct-to-total energy ratio parameter, and
the second signal energy parameter; and
selecting, based on a comparison of the at least one first weighting value and the second weighting value, one of the at least one first direct-to-total energy ratio parameter or the diffuse-energy compensated direct-to-total energy ratio parameter.
